(19) United States
(12) Patent Application Publication
(10) Pub. No.: US 2011/0063244 A1
(43) Pub. Date: Mar. 17, 2011

(54) OPTICAL FILM AND DISPLAY MODULE USING THE SAME

(75) Inventors: RUI-BIN HU, Shenzhen (CN); FEI-HONG CHEN, Shenzhen (CN)

(73) Assignees: INNOCOM TECHNOLOGY (SHENZHEN) CO., LTD., Shenzhen City (CN); INNOLUX DISPLAY CORP., Miao-Li County (TW)

(21) Appl. No.: 12/711,664

(22) Filed: Feb. 24, 2010

(30) Foreign Application Priority Data
Sep. 17, 2009 (CN) 200910307154.4

(51) Int. Cl. G06F 3/044; B32B 33/00; B32B 5/00; G02B 27/00

(52) U.S. Cl. 345/174; 428/354; 428/40.1; 428/335; 428/334; 428/336; 359/609

(57) ABSTRACT

An optical film includes a hard coating layer, an anti-glare layer, a first adhesive layer, and a second adhesive layer. The hard coating layer is a hard and transparent material, and the anti-glare layer is adhered on a first side of the hard coating layer. The first adhesive layer is adhered on one side of the anti-glare layer away from the hard coating layer, and the second adhesive layer is adhered on a second side of the hard coating layer opposite to the first side. A thickness of the optical film can be 0.19˜0.23 mm. The present disclosure further provides a display module using the optical film.

### BACKGROUND

1. Technical Field

The present disclosure relates to an optical film and a display module using the optical film.

2. Description of Related Art

A commonly used display module with a display panel may further include a touch panel formed on the display panel to replace traditional input devices, such as control buttons, mice, keyboards, etc. to facilitate users' input by contact.

Touch panels can be resistance, capacitance, electronic-magnetic, exterior sound wave, infrared ray, and other types. Capacitance touch panels provide multi-touch function, durability, and long lifespan, therefore, they are popularly used.

Display modules, whether in the form of cathode ray tube, flat panel, or touch panel, require a plurality of optical films to be deployed for protecting the display panel, improving the image quality, and improving viewability. Referring to FIG. 3, a clear optical adhesive 100 includes an adhesive layer 102 and two release layers 104, 106. The adhesive layer 102 adheres to the panels or films. The release layers 104, 106 are formed on opposite sides of the adhesive layer 102 to protect the clear optical adhesive 100 from attracting impurities before use.

Referring to FIG. 4, an anti-reflection film 200 includes a base layer 202, a tri-acetyl cellulose (TAC) layer 204 formed on the base layer 202, the adhesive layer 102, and the release layer 104/106 formed on the adhesive layer 102. The TAC layer 204 resists glare and reflection. Typically, the thickness of the base layer 202 is about 0.005 mm, of the adhesive layer 102 is about 0.025˜0.175 mm, and of the TAC layer 204 is about 0.08 mm, resulting in a total thickness of the anti-reflection film 200 of about 0.11˜0.26 mm. The anti-reflection film 200 is frequently used in the display module to reduce reflections between the panels, such that the image quality of the display module is improved.

Also referring to FIG. 5, a capacitance display module 300 includes a thin displaying layer 310 having a liquid crystal display (LCD) panel, a plurality of adhesive layers 102, an anti-reflection film 200, a capacitance touch panel 320, and a protective film 330. The anti-reflection film 200 is adhered to one side of the capacitance touch panel 320 which is facing the LCD panel 310 through the adhesive layer 102 by removing the release layer 104/106 of the anti-reflection film 200. The base layer 202 of the anti-reflection film 200 is adhered to the LCD panel 310 by one of the adhesive layers 102 of the anti-reflection film 200. The protective film 330 is adhered to the other side of the capacitance touch panel 320 away from the LCD panel 310 through one of the adhesive layers 102 of the clear optical adhesive 100. In this capacitance display module 300, various layers, such as the adhesive layers 102, the anti-reflection layer 200, and the protective film 330 are added to adhere, resist reflection, or protect the capacitance display module 300, with at least two or three layers between the LCD panel 310 and the capacitance touch panel 320 being added. The total thickness of the layers between the LCD panel 310 and the capacitance touch panel 320 is not less than 0.29 mm. The thickness of the capacitance display module 300 is increased, and time required for adhesion is increased, as manpower and equipment requirements, and rate of quality defect is increased. Furthermore, the capacitance display module 300 having a larger thickness may decrease the permeation of light.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a cross-section of one embodiment of an optical film.

FIG. 2 is a cross-section showing a display module using the optical film of FIG. 1.

FIG. 3 is a cross-section of a typical clear optical adhesive including an adhesive layer and two release layers.

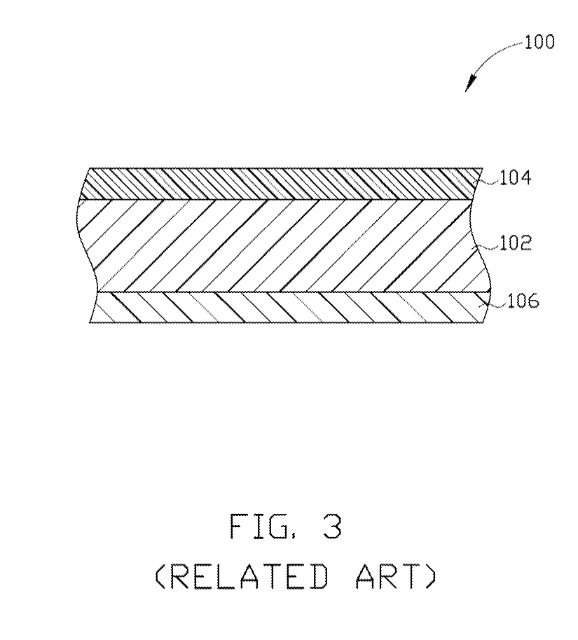

FIG. 4 is a cross-section of a commonly used anti-reflection film.

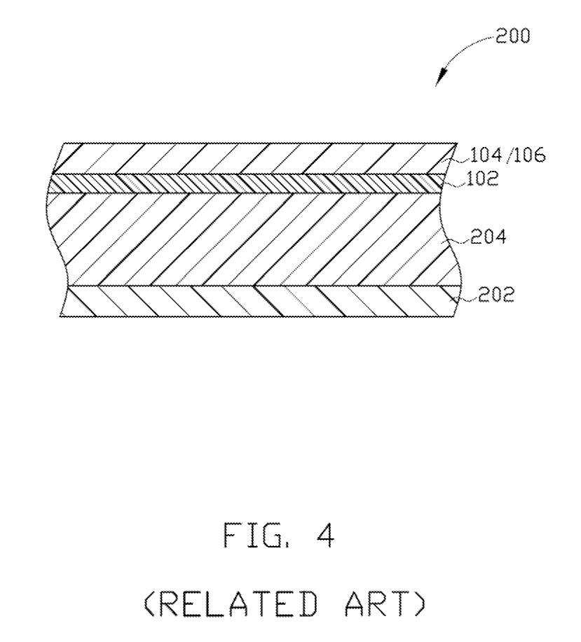

FIG. 5 is a cross-section of a commonly used capacitance display module including the anti-reflection film, the adhesive layer, and the release layer.

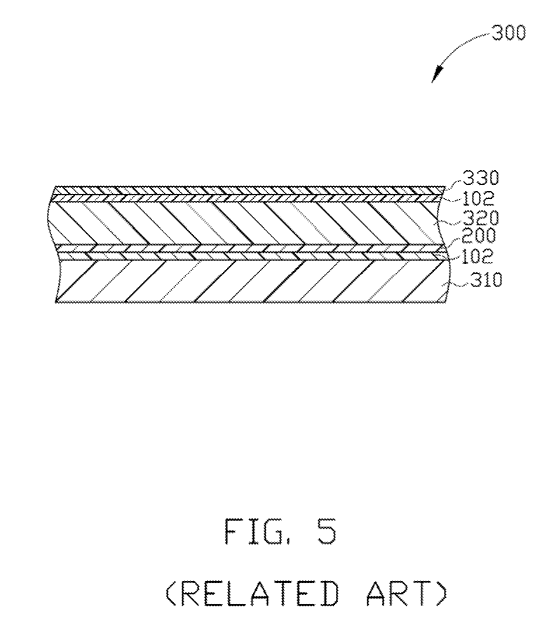

### DETAILED DESCRIPTION

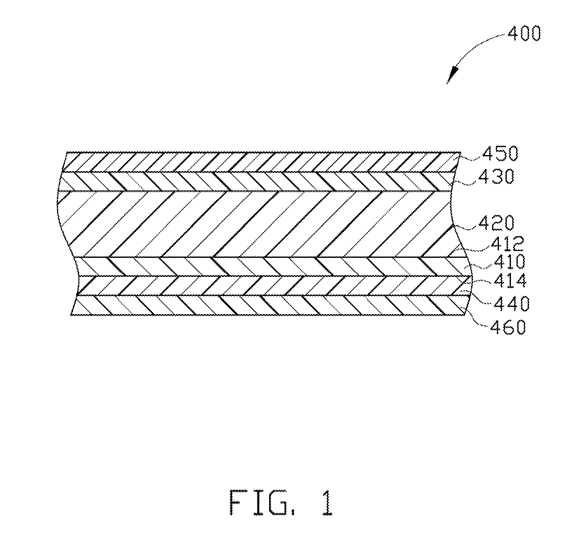

Referring to FIG. 1, one embodiment of an optical film 400 includes a hard coating layer 410, an anti-glare layer 420, a first adhesive layer 430, a second adhesive layer 440, a first release layer 450, and a second release layer 460. The anti-glare layer 420 is adhered on a first side of the hard coating layer 410, and the second adhesive layer 440 is adhered on a second side of the hard coating layer 410 opposite to the first side. The first adhesive layer 430 is adhered on one side of the anti-glare layer 420 away from the hard coating layer 410, and the first release layer 450 is formed on one side of the first adhesive layer 430 away from the anti-glare layer 420. The second release layer 460 is formed on one side of the second adhesive layer 440 away from the hard coating layer 410.

The hard coating layer 410 has a first surface 412 and a second surface 414 opposite to the first surface 412. The anti-glare layer 420 is adhered on the first surface 412, and the second adhesive layer 440 is adhered on the second surface 414. The hard coating layer 410 may be polyester resin such as polyethylene terephthalate (PET), or polyacrylate resin such as polymethyl methacrylate (PMMA) or polycarbonate (PC) and other, or combinations thereof. In the illustrated embodiment, the hard coating layer 410 is PET of 0.03˜0.05 mm thick. The hard coating layer 410 is a base layer of the optical film 400. The hard coating layer 410 is PET so as to be able to provide superior hardness, durability, stability, fatigue resistance, and good light transmittance. The hard coating layer 410 may be of other materials with favorable hardness and transparency.

The anti-glare layer 420 is TAC (tri-acetyl cellulose) of thickness less than or equal to 0.08 mm. In the illustrated embodiment, the thickness of the anti-glare layer 420 is 0.08 mm.

The first and second adhesive layers 430, 440 are made of optical adhesive with a good light transmittance and a high cohesive force such as acrylic resin. A thickness of each of the first adhesive layer 430 and the second adhesive layer 440 is 0.04˜0.05 mm. In the illustrated embodiment, the thickness of each of the first adhesive layer 430 and the second adhesive layer 440 is 0.05 mm. Alternatively, the first adhesive layer 430 and the second adhesive layer 440 may have different thicknesses.

The first and second release layers 450, 460 prevent the optical film 400 from attracting impurities before use. In the illustrated embodiment, a total thickness of the optical film 400 is 0.19˜0.23 mm.

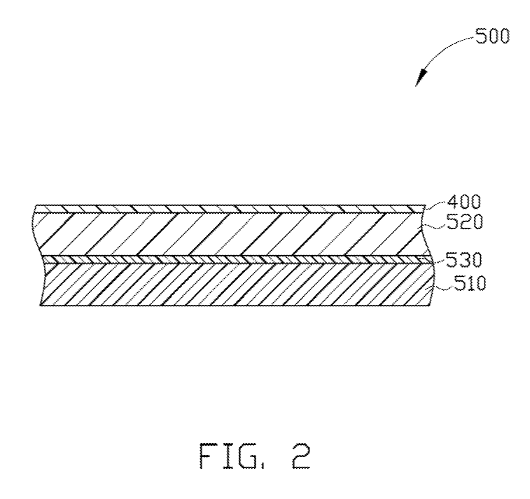

Also referring to FIG. 2, a display module 500 includes a display panel 510 such as a LCD panel, a capacitance touch panel 520, an optical adhesive 530, and the optical film 400. The capacitance touch panel 520 is a double-sided indium tin oxide board, and is adhered to the display panel 510 by the optical adhesive 530. The optical film 400 is adhered to one side of the capacitance touch panel 520 away from the display panel 510 by removing the second release layer 460 of the optical film 400 and adhering the second adhesive layer 440 of the optical film 400 to the capacitance touch panel 520.

Since the hard coating layer 410 provides durability, stability, fatigue resistance, and transparency, no protective film for the display module 500 is required. Accordingly, the required thickness of the display module 500 is decreased. In addition, the hard coating layer 410 acts both as a base layer of the anti-glare layer 420 and a protective film, such that the display panel 510 is protected from physical damage and the quality of light transmittance of the display module 500 is improved. Since the optical film 400 includes the first adhesive layer 430 and the second adhesive layer 440 on opposite sides, the optical film 400 is thereby easily adhered to other films or panels. In the display module 500, since lesser adhesive layers are used, adhering time and manpower requirements are decreased, and the adhesion process is simplified. Furthermore, the product yield rate is increased.

It is believed that the present embodiments and their advantages will be understood from the foregoing description, and it will be apparent that various changes may be made thereto without departing from the spirit and scope of the embodiments or sacrificing all of their material advantages.

What is claimed is:

1. An optical film for a display module comprising:
a hard coating layer of a hard and transparent material;
an anti-glare layer adhered on a first side of the hard coating layer;
a first adhesive layer adhered on one side of the anti-glare layer away from the hard coating layer; and
a second adhesive layer adhered on a second side of the hard coating layer opposite to the first side.

2. The optical film of claim 1, further comprising a first release layer formed on one side of the first adhesive layer away from the anti-glare layer and a second release layer formed on one side of the second adhesive layer away from the hard coating layer.

3. The optical film of claim 1, wherein the hard coating layer is polyester resin, polyacrylate resin, or a combination thereof.

4. The optical film of claim 3, wherein the polyester resin is polyethylene terephthalate, and the polyacrylate resin is polymethyl methacrylate or polycarbonate.

5. The optical film of claim 1, wherein a thickness of the hard coating layer is 0.03˜0.05 mm.

6. The optical film of claim 1, wherein the anti-glare layer is tri-acetyl cellulose.

7. The optical film of claim 5, wherein a thickness of the anti-glare layer is less than or equal to 0.08 mm.

8. The optical film of claim 6, wherein a thickness of the anti-glare layer is 0.08 mm.

9. The optical film of claim 1, wherein a thickness of each of the first adhesive layer and the second adhesive layer is 0.04˜0.05 mm.

10. The optical of claim 9, wherein the thickness of each of the first adhesive layer and the second adhesive layer is 0.05 mm.

11. A display module comprising:
a display panel;
a capacitance touch panel adhered on one side of the display panel; and
an optical film adhered on one side of the capacitance touch panel away from the display panel, wherein the optical film comprises a hard coating layer, an anti-glare layer, a first adhesive layer, and a second adhesive layer, the hard coating layer is made of a hard and transparent material, the anti-glare layer is adhered on one side of the hard coating layer, the first adhesive layer is adhered on one side of the anti-glare layer away from the hard coating layer, and the second adhesive layer is adhered on the other side of the hard coating layer.

12. The display module of claim 11 further comprising an optical adhesive, wherein the capacitance touch panel is adhered to the display panel through the optical adhesive.

13. The display module of claim 11, wherein the optical film further comprises a first release layer formed on one side of the first adhesive layer away from the anti-glare layer and a second release layer formed on one side of the second adhesive layer away from the hard coating layer.

14. The display module of claim 11, wherein the hard coating layer of the optical film is polyester resin, polyacrylate resin, or a combination thereof.

15. The display module of claim 14, wherein the polyester resin is polyethylene terephthalate, and the polyacrylate resin is polymethyl methacrylate or polycarbonate.

16. The display module of claim 11, wherein a thickness of the hard coating layer is 0.03˜0.05 mm.

17. The display module of claim 11, wherein the anti-glare layer is made of tri-acetyl cellulose.

18. The display module of claim 17, wherein a thickness of the anti-glare layer is less than or equal to 0.08 mm.
